(19) United States
(12) Patent Application Publication
(10) Pub. No.: US 2012/0149558 A1
(43) Pub. Date: Jun. 14, 2012

(54) Catalyst for hydrodechlorination of chlorosilanes to hydrogen silanes and method for implementing hydrogen silanes using said catalyst

(75) Inventors: Alexander Zipp, Munchen (DE); Hans-Jürgen Eberle, Munchen (DE)

(73) Assignee: Wacker Chemie AG, Munich (DE)

(21) Appl. No.: 13/390,850

(22) PCT Filed: Aug. 12, 2010
(86) PCT No.: PCT/EP2010/061780

§ 371 Date: Feb. 16, 2012

(30) Foreign Application Priority Data
Aug. 19, 2009 (DE) 10 2009 028 653.5

(51) Int. Cl. C07F 7/14; B01J 23/80; B01J 21/08; C01B 33/107; B01J 23/06

(52) U.S. Cl. 502/253; 423/342; 502/343; 502/244; 556/475

(57) ABSTRACT

The invention relates to a method for producing hydrogen silanes of general formula RₙCl₃₋ₙSiH by converting chlorosilanes of general formula RₙCl₄₋ₙSi, where R, in both formulas simultaneously and independently of each other, is a hydrogen atom, an optionally substituted or unsubstituted hydrocarbon radical having 1 to 18 carbon atoms, and n can have the value of 1-3, and hydrogen gas in the presence of a catalytic quantity (K): zinc and/or an alloy comprising zinc on a metal oxide carrier.

### CROSS REFERENCE TO RELATED APPLICATIONS

This application is the national phase filing of international patent application No. PCT/EP2010/061780, filed 12 Aug. 2010, and claims priority of German patent application number 10 2009 028 653.5, filed 19 Aug. 2009, the entireties of which applications are incorporated herein by reference.

### FIELD OF THE INVENTION

The invention relates to a process for preparing hydrogensilanes by catalytic hydrogenation of chlorosilanes by means of hydrogen gas in the presence of a heterogeneous catalyst based on metallic zinc and also to the catalyst.

The process of the invention is, for example, suitable for the hydrodechlorination of the tetrachlorosilane obtained in large quantities in the preparation of pure silicon to trichlorosilane, with the latter being able, for example, to be reused for the deposition of silicon or be reacted further by the process of the invention to form its homologues dichlorosilane, chlorosilane and monosilane.

A further use of the process of the invention is, for example, the preparation of hydrogenalkylchlorosilanes from alkylchlorosilanes. In the process for preparing methylchlorosilanes known as the Müller-Rochow process, methyl chloride is reacted with elemental silicon. This gives a mixture of silanes containing the chlorosilanes such as methyltrichlorosilane and dimethyl-dichlorosilane together with, inter alia, hydrogensilanes such as methyldichlorosilane and dimethylchlorosilane. These hydrogensilanes are of great interest since they can, for example, be converted into further organofunctional silanes by hydrosilylation reactions. Since the hydrogensilanes occur only as coproducts in the Müller-Rochow synthesis, their availability is greatly limited. The targeted conversion of the chlorosilanes into hydrogensilanes decoupled from the Müller-Rochow process is therefore of interest.

### BACKGROUND OF THE INVENTION

Various processes for preparing hydrogensilanes from chlorosilanes are known.

According to the prior art, the hydrodechlorination of high-purity tetrachlorosilane is usually carried out by thermal converting at very high temperatures.

Thus, U.S. Pat. No. 3,933,985 describes the reaction of tetrachlorosilane with hydrogen to form trichlorosilane at temperatures in the range from 900° C. to 1200° C. and a molar ratio of H₂:SiCl₄ of from 1:1 to 3:1. Yields of 12-13% are described.

The patent U.S. Pat. No. 4,217,334 reports an optimized process for converting tetrachlorosilane into trichlorosilane by hydrogenation of tetrachlorosilane by means of hydrogen in a temperature range from 900° C. to 1200° C. A high molar ratio of H₂:SiCl₄ (up to 50:1) and a liquid quench of the hot product gas to below 300° C. enables significantly higher trichlorosilane yields (up to about 35% at H₂:tetrachlorosilane of 5:1) to be achieved. Disadvantages of this process are the significantly higher proportion of hydrogen in the reaction gas and the quench by means of a liquid which is employed, both of which greatly increase the energy requirement of the process and thus the costs.

Apart from these purely thermal processes, reactions with complex metal hydrides known from the literature, for example sodium or lithium aluminum hydride, and in particular stoichiometric reactions with base metals are also known.

Thus, U.S. Pat. No. 5,329,038 describes a process in which hydrogensilanes are obtained from chlorosilanes by reaction with a hydrogen source and aluminum and chloride scavenger in the presence of a catalyst selected from the group consisting of copper, zinc and tin, with the aluminum having to be used in a stoichiometric amount and the corresponding aluminum chloride being obtained as coproduct.

A similar process is described in U.S. Pat. No. 2,406,605 where the reaction is carried out using stoichiometric amounts of aluminum, magnesium or zinc and without catalyst but likewise with equimolar amounts of the corresponding chlorides being formed.

EP0412342 describes a process in which finely divided aluminum is reacted with hydrogen in a salt melt composed of aluminum chloride and sodium chloride to form the hydride and the latter is used and consumed in the conversion of halogen-substituted compounds of the 2nd to 4th periods into the corresponding hydrogenated compounds.

EP0714900 describes a process in which chlorosilanes are reacted with hydrogen over heterogeneous catalysts consisting of a metal selected from the group consisting of ruthenium, rhodium, palladium, osmium, iridium and platinum on a support material to form the corresponding hydrogenated derivatives.

It is common to all these known processes that they operate at very high temperatures or use stoichiometric amounts of chloride scavengers or the coproducts and by-products obtained or the use of metal and salt melts which are problematical in process engineering terms make the processes uneconomical or, particularly in the case of stoichiometric reactions, significant amounts of by-products are formed.

### SUMMARY OF THE INVENTION

It was therefore an object of the invention to improve the prior art and in particular to develop an economically and universally applicable process which allows a heterogeneously catalyzed hydrodechlorination of chlorosilanes by means of molecular hydrogen in an industrially handleable temperature range.

It has surprisingly been found that hydrogensilanes can be obtained in the reaction of any chlorosilanes with hydrogen gas in the presence of a catalytic amount of elemental zinc in a support composed of metal oxide at elevated temperature.

### DETAILED DESCRIPTION OF THE INVENTION

The invention accordingly provides a process for preparing hydrogensilanes of the general formula

RₙCl₃₋ₙSiH

by reacting chlorosilanes of the general formula

RₙCl₄₋ₙSi

where the radicals R in both formulae are each, simultaneously and independently of one another, a hydrogen atom, an optionally substituted or unsubstituted hydrocarbon radical having from 1 to 18 carbon atoms, preferably an optionally substituted or unsubstituted alkyl or aryl radical preferably having from 1 to 18 carbon atoms, more preferably from 1 to 12 carbon atoms, even more preferably from 1 to 8 carbon atoms, particularly preferably a methyl, phenyl or ethyl radical, and n is 1-3, with hydrogen gas in the presence of a catalytic amount (K) of:
zinc and/or a zinc-containing alloy preferably distributed on a support based on a preferably high-melting metal oxide.

In the process of the invention, it is possible to use, preferably, one type of chlorosilane or a mixture of a number of types of chlorosilanes.

The products tetrachlorosilane, methyltrichlorosilane and dimethyldichlorosilane which are also obtained in the Müller-Rochow process are preferably used in the process of the invention.

The process of the invention is carried out at temperatures above the dew point of a mixture of the chlorosilane used and hydrogen in the gas phase, with preference being given to carrying out the process at temperatures above the melting point of zinc; the process of the invention is preferably carried out at a temperature in the range from 300° C. to 800° C., preferably from 300° C. to 600° C., particularly preferably from 450° C. to 600° C.

Zinc-containing alloys are preferably zinc, brass and/or bronze.

The catalyst zinc is preferably used in amounts of from 0.1 to 99.9% by weight, preferably in amounts of from 1 to 50% by weight, particularly preferably in amounts of from 5 to 30% by weight, of elemental zinc based on the total solid catalyst (K). The catalyst zinc plus support is preferably also used in the support in the sense that the catalyst zinc is located in a porous support on the internal surface area of the support. As support, preferably a matrix, i.e. preferably a framework, preference is given to one or more preferably high-melting metal oxides selected from the group consisting of silicon dioxide, aluminum oxide, zinc oxide, titanium dioxide, zirconium dioxide and mixed oxides thereof, e.g. preferably aluminosilicates, preferably zeolites and any mixtures thereof, with silicon dioxide being preferred and pyrogenic silicon dioxide being particularly preferred. The heterogeneous solid can additionally contain preferably small amounts of one or more promoters selected from the group consisting of copper, tin and silicon or these substances in any mixtures, where these are present in ratios of preferably from 0.01 to 1, particularly preferably from 0.25 to 1, based on the amount of elemental zinc, with copper being preferred and up to half of the weight of zinc being able to be replaced, i.e. in a ratio of 1:1 of zinc to promoter, preferably copper. The support is preferably porous.

The reaction of the chlorosilanes and a hydrogen-containing gas mixture over the catalyst of the invention is usually carried out at a gas hourly space velocity (GHSV) in the range of preferably from 100 to 10,000, preferably from 250 to 2500, particularly preferably from 500 to 1000, per hour, with the proportion of the chlorosilanes to be reacted in the gas mixture being in the range from 1 to 90% by volume, preferably from 5 to 50% by volume and particularly preferably from 20 to 40% by volume.

The hydrogensilanes produced in the process of the invention can, owing to their low boiling point, preferably be separated from the unreacted chlorosilanes by distillation. The unreacted chlorosilanes are preferably recirculated and reused for a reaction.

The process of the invention can be carried out either batchwise or continuously.

The invention further provides a catalyst K which contains: zinc or a zinc-containing alloy preferably distributed on a support based on a preferably high-melting metal oxide.

The catalyst K, which is preferably porous, is produced by dispersing preferably one or more metal oxides selected from the group consisting of silicon dioxide, aluminum oxide, titanium dioxide, zirconium dioxide and mixed oxides thereof, preferably aluminosilicates, preferably zeolites and any mixtures thereof, with silicon dioxide being preferred and pyrogenic silicon dioxide being particularly preferred, in distilled water and adding metallic zinc and optionally one or more promoters from the group consisting of copper, tin and silicon and any mixtures thereof to the composition. This composition is extruded and preferably dried to give cylinders having a length of preferably from 4 mm to 20 mm, more preferably from 4 mm to 10 mm, and a diameter of preferably from 1 mm to 6 mm, more preferably from 3 mm to 6 mm. In addition, the composition can also be pressed to give any shape, preferably to form pellets, rings or tablets, and can preferably also have one or more openings. The metallic catalyst zinc is added in amounts of from 0.1 to 99.9% by weight, preferably in amounts of from 1 to 50% by weight, particularly preferably in amounts of from 5 to 30% by weight, based on the solid catalyst (K), i.e. catalyst plus support; promoters preferably selected from the group consisting of copper, tin and silicon are optionally added in ratios of preferably from 0.01 to 1, particularly preferably from 0.25 to 1, based on the amount of elemental zinc.

The following examples illustrate the present invention without restricting its scope.

### Example 1

### Hydrodechlorination of Tetrachlorosilane

30 g of pyrogenic silica is dispersed in 70 g of distilled water and metallic zinc corresponding to a proportion of 1% by weight based on the total solid is added to the composition. The composition is subsequently extruded to form extrudates and dried. 10 g of the dry catalyst are introduced into a tube reactor and firstly treated with hydrogen at 500° C. for hours. A mixture of 20% by volume of tetrachlorosilane in hydrogen is passed over the catalyst at 450° C. at a GHSV of 625 per hour and the composition of the exiting product mixture is determined by gas chromatography.

The amount of trichlorosilane formed is significantly above that corresponding to a stoichiometric reaction of 2 mol of SiHCl₃ per mole of zinc. A TON (turnover number) of 225 was achieved up to the end of the experiment after about 48 hours.

### Example 2

### Hydrodechlorination of Methyltrichlorosilane

30 g of pyrogenic silica is dispersed in 70 g of distilled water and metallic zinc corresponding to a proportion of 1% by weight based on the total solids is added to the composition. The composition is subsequently extruded to form extrudates, cut and dried using a ram extruder. 10 g of the dry catalyst are introduced into a tube reactor and firstly treated with hydrogen at 500° C. for 2 hours. A mixture of 20% by volume of methyltrichlorosilane in hydrogen is passed over the catalyst at 450° C. at a GHSV of 625 per hour and the chemical composition of the exiting product mixture is determined by gas chromatography.

At a theoretical stoichiometric conversion, a maximum of 2 mol of dichloromethylsilane would be formed per mole of zinc. The results show a significantly superstoichiometric formation of methyldichlorosilane as reaction product of the hydrodechlorination of methyltrichlorosilane, corresponding to a TON of 120 to conclusion of the experiment after about 36 hours.

### Example 3

### Hydrodechlorination of Methyltrichlorosilane

30 g of pyrogenic silica is dispersed in 70 g of distilled water and catalytically active metals corresponding to the following table in % by weight based on the total solids is added to the composition. The composition is subsequently extruded to form extrudates and dried. 10 g of the dry catalyst are introduced into a tube reactor and firstly treated with hydrogen at 500° C. for 2 hours. A mixture of 20% by volume of methyltrichlorosilane in hydrogen is passed over the catalyst at 450° C. at a GHSV of 625 h⁻¹ and the chemical composition of the exiting product mixture is determined by gas chromatography. The results are shown in the form of the steady-state yields in the following table.

| Active component(s) | Yield |
|---|---|
| 25% by weight of Zn | 8.4% |
| 50% by weight of Zn | 2.7% |
| 75% by weight of Zn | 1.0% |
| 12.5% by weight of Zn, 12.5% by weight of Cu | 10.0% |

1. A process for preparing hydrogensilanes of the general formula
RₙCl₃₋ₙSiH
by reacting chlorosilanes of the general formula
RₙCl₄₋ₙSi
where the radicals R in both formulae are each, simultaneously and independently of one another, a hydrogen atom, an optionally substituted or unsubstituted hydrocarbon radical having from 1 to 18 carbon atoms, and n is 1-3, with hydrogen gas in the presence of a catalytic amount of a catalyst(K) comprising:
zinc and/or a zinc-containing alloy on a support based on metal oxide.

2. The process for preparing hydrogensilanes as claimed in claim 1, wherein the metal oxide is silicon dioxide, aluminum oxide, titanium dioxide, zirconium dioxide or a mixed oxide thereof.

3. The process for preparing hydrogensilanes as claimed in claim 2, wherein the metal oxide is pyrogenic silicon dioxide.

4. The process for preparing hydrogensilanes as claimed in claim 1, wherein (K) additionally contains one substance selected from the group consisting of copper, tin, silicon and mixtures of any of these.

5. The process for preparing hydrogensilanes as claimed in claim 1, wherein the zinc and/or zinc-containing alloy is present in the support in an amount of from 5% by weight to 30% by weight of elemental zinc based on (K).

6. The process for preparing hydrogensilanes as claimed in claim 1, wherein the process is carried out at from 300° C. to 600° C.

7. A catalyst, wherein the catalyst (K) contains zinc and/or a zinc-containing alloy on a support based on metal oxide.

8. The catalyst as claimed in claim 7, wherein the metal oxide is silicon dioxide, aluminum oxide, titanium dioxide, zirconium dioxide or a mixed oxide thereof.

9. The catalyst as claimed in claim 8, wherein the metal oxide is pyrogenic silicon dioxide.

10. The catalyst as claimed in claim 9, wherein the catalyst (K) additionally contains one substance selected from the group consisting of copper, tin, silicon and mixtures of any of these.
